(19) United States
(12) Patent Application Publication
(10) Pub. No.: US 2014/0196519 A1
(43) Pub. Date: Jul. 17, 2014

(54) METHOD FOR MEASURING AMOUNT OF PARTICULATE MATTER ACCUMULATED IN AN EXHAUST GAS PURIFICATION FILTER

(71) Applicants: Eiichi Takahashi, Ibaraki (JP); Osamu Shinozaki, Ibaraki (JP); Takehiko Segawa, Tsukuba-shi (JP); Hirohide Furutani, Tsukuba-shi (JP)

(72) Inventors: Eiichi Takahashi, Ibaraki (JP); Osamu Shinozaki, Ibaraki (JP); Takehiko Segawa, Tsukuba-shi (JP); Hirohide Furutani, Tsukuba-shi (JP)

(21) Appl. No.: 14/123,314

(22) PCT Filed: May 18, 2012
(86) PCT No.: PCT/JP2012/062783

§ 371 Date: Feb. 12, 2014

(30) Foreign Application Priority Data
Jun. 3, 2011 (JP) 2011-125080

(51) Int. Cl. G01N 29/032; G01M 15/10

(52) U.S. Cl. CPC G01N 29/032; G01M 15/102
USPC 73/23.31

(57) ABSTRACT

A measurement method capable of accurately evaluating the trapped amount of particulate matter (PM) accumulated in a diesel particulate filter (DPF) is provided. The method for measuring the amount of accumulated particulate matter comprises propagating ultrasonic waves generated by a transmitter 3 provided directly to the DPF or outside a container and insulation material 6 having a property that propagates ultrasonic waves, measuring the amount of PM accumulated in the DPF 2 using a receiver 4, the DPF being composed of porous ceramic and disposed at an intermediate point in the exhaust pipe 1 of a diesel engine, and determining the amount of accumulated PM on the basis of the results.

### TECHNICAL FIELD

The present invention relates to a method for measuring the amount of accumulated particulate matter for accurately evaluating the amount of accumulated particulate matter trapped in an exhaust gas purification filter in a method of regenerating the exhaust gas purification filter that purifies exhaust gas by trapping particulate matter in exhaust gas from a diesel engine or the like.

### BACKGROUND ART

A diesel particulate filter for a diesel engine (hereinafter, referred to as DPF) purifies exhaust gas and particulate matter (hereinafter, referred to as PM) by filtering the PM discharged from the diesel engine when the PM passes through porous ceramic walls carrying catalysts. However, since the DPF can trap the limited amount of the PM, the DPF requires “regeneration operation” where the DPF is regularly heated to a high temperature by self-heating or external heating such as electrification to burn off the PM.

In the regeneration, when the amount of accumulated PM is excessively great, damage to the filter is caused by generation of thermal stress. In contrast, when the regeneration is unnecessarily frequently operated to keep the amount of accumulated PM low, the regeneration operation requires extra energy for heating the DPF, and thus fuel consumption deteriorates. In order to improve fuel consumption of a diesel engine, it is necessary to accurately determine the time of regeneration for achieving the necessary minimum frequency of the regeneration without regard to a concern of the DPF being damaged, and to accurately measure the amount of accumulated PM.

In the related art, as a method of measuring the amount of accumulated PM trapped in the DPF, the following methods are disclosed: an evaluation by a pressure difference (pressure loss) between an upstream and a downstream of a filter (for example, refer to PTL 1); and a method of estimating the amount of accumulated PM based on driving hours using a computer (for example, refer to PTL 2). In addition, it is attempted to provide an acoustic source and an acoustic receiver in upstream and downstream exhaust pipes of a filter (for example, refer to PTL 3).

### CITATION LIST

### Patent Literature

[PTL 1] JP-A-2005-023884

[PTL 2] JP-A-2004-316428

[PTL 3] JP-T-2005-538304

### SUMMARY OF INVENTION

### Technical Problem

In the related art, in the evaluation by a pressure difference between an upstream and a downstream of a filter, there is a problem in that it is difficult to accurately evaluate accumulation of PM since the pressure loss has a tendency of being saturated early compared to the accumulation of the PM. In the method of estimating the amount of accumulated PM based on driving hours using a computer, there is a problem in that it is necessary to construct a database and to develop a complicated program relative to generation of the PM under driving conditions of individual engines since the amount of generated PM is complicatedly dependent on various conditions such as driving history of an engine. In addition, in the method of providing an acoustic source and an acoustic receiver in exhaust pipes, there is a problem in that an accurate evaluation is difficult due to the influence of temperature, flow velocity or the like of exhaust gas and a sensor deteriorates under exhaust gas atmosphere.

In order to solve the problem, an object of the present invention is to provide a new method of evaluating the amount of accumulated PM so as to determine the time of regeneration for achieving the necessary minimum frequency of the regeneration without regard to a concern of a DPF being damaged.

### Solution to Problem

In order to solve the problem, according to the present invention, there is provided a method of measuring the amount of particulate matter (PM) accumulated in an exhaust gas purification apparatus with which a diesel engine is equipped, wherein a diesel particulate filter (DPF) configured to have a porous ceramic is connected to an intermediate point in an exhaust pipe, a container containing the DPF or the like has an ultrasonic wave transmitter for propagating an ultrasonic wave and an ultrasonic wave receiver for receiving an ultrasonic wave on an exterior thereof, and the amount of the PM accumulated in the DPF is evaluated based on attenuation of a detected signal of the ultrasonic wave propagating through a main DPF body using a control apparatus that processes the detected signal of the ultrasonic wave receiver.

In addition, in the method of measuring the amount of accumulated PM according to the present invention, the control apparatus evaluates the amount of the PM accumulated in the DPF based on attenuation obtained by comparing amplitude of a detected signal of an ultrasonic wave propagating through the main DPF body when the PM is not accumulated with amplitude of a detected signal of an ultrasonic wave propagating through the main DPF body when the PM is accumulated, and the control apparatus determines that it is necessary to operate regeneration of the DPF when the attenuation exceeds a constant value.

In addition, in the method of measuring the amount of accumulated PM according to the present invention, an ultrasonic wave of several MHz frequency range is used.

In addition, in the method of measuring the amount of accumulated PM according to the present invention, a heat insulator made of a material which prevents signal attenuation of an ultrasonic wave is arranged between the main DPF body and the container containing the main DPF body.

### Advantageous Effects of Invention

In the method of measuring the amount of accumulated PM according to the present invention, since the ultrasonic wave transmitter and the ultrasonic wave receiver are provided on the exterior of the DPF container to detect an ultrasonic wave propagating through the main DPF body, the method is unlikely to be affected by flow velocity or temperature of exhaust gas and the amount of the accumulated PM can be accurately measured. Accordingly, the frequency of regenerating the DPF is set to be the necessary minimum and fuel consumption can be improved. In addition, in a simple configuration in which the ultrasonic wave transmitter and the ultrasonic wave receiver are provided on the exterior of the DPF container to detect an ultrasonic wave propagating through the main DPF body, the amount of the accumulated PM can be accurately detected, a sensor has no risk of deterioration due to a part of the sensor not being exposed to exhaust gas atmosphere, and a measurement can also be performed after retrofit of the apparatus.

In addition, since an ultrasonic wave of several MHz frequency range is used, it is possible to effectively read attenuation of the ultrasonic wave propagating in a lateral direction through the main DPF body in association with the amount of the accumulated PM.

In addition, when a heat insulator made of a material which prevents signal attenuation of an ultrasonic wave is arranged between the main DPF body and the container containing the main DPF body, it is possible to insulate the DPF against heat without deteriorating the precision of measurement.

### BRIEF DESCRIPTION OF DRAWINGS

FIG. 1 is a view describing an example of an exhaust gas purification apparatus for carrying out a method of measuring the amount of accumulated PM according to the present invention. A view on an upper side of FIG. 1 indicates a cross-sectional view of an exhaust pipe in an axial direction (a cross-sectional view of a DPF taken along a direction where exhaust gas enters and exits the DPF, that is, in a longitudinal direction). A view on a lower side indicates a cross-sectional view orthogonal to the axis of the exhaust pipe (a cross-sectional view in a direction where cells of the DPF are bundled, that is, in a lateral direction).

FIG. 2 is a view illustrating an example of a waveform of a detected signal detected by an ultrasonic wave receiver of FIG. 1. A waveform on an upper side in FIG. 2 indicates a waveform of a detected signal when the DPF is not charged with PM. A view on a lower side indicates a waveform of a detected signal when the DPF is charged with PM.

### DESCRIPTION OF EMBODIMENTS

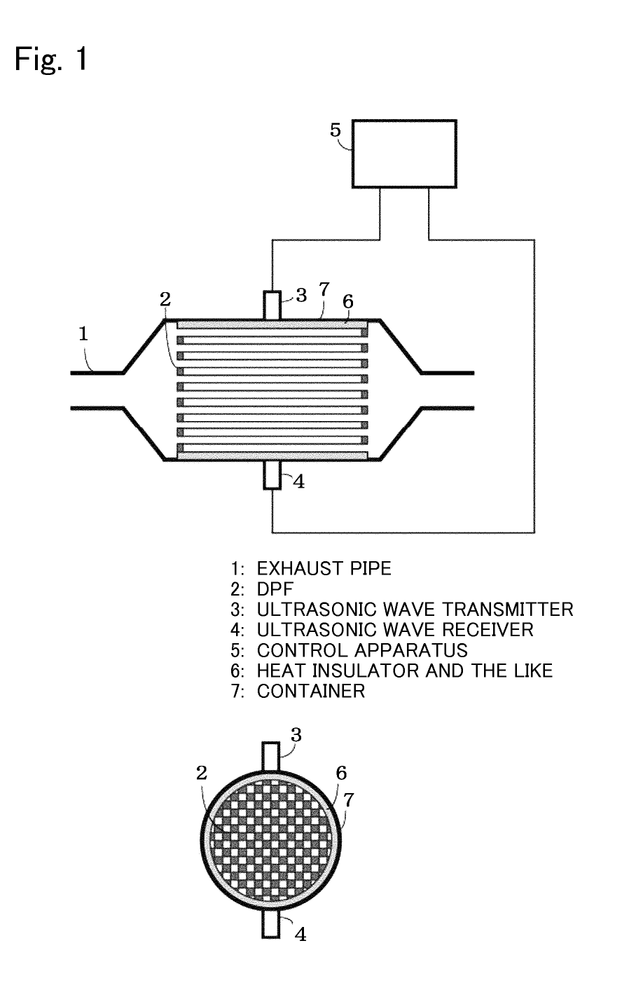

FIG. 1 illustrates an example of an exhaust gas purification apparatus for carrying out a method of measuring the amount of accumulated PM according to the present invention. A DPF is configured to have a honeycomb-shaped porous ceramic and the like, and a plurality of slender cells (in the drawing, the slender cells have a rectangular columnar shape, but the cells may have another shape such as a hexagonal columnar shape) divided by partition walls. Exhaust gas from a diesel engine is introduced into the cells of the DPF. An end portion of each cell is blocked, and the exhaust gas always passes through fine pores in the partition walls and discharges from the DPF. Accordingly, PM is accumulated on the surfaces of the partition walls or inside the pores. Typically, an exit and entrance of each cell which configures a honeycomb structure has a size of several millimeters. Hereinafter, a direction where exhaust gas enters and exits the DPF is referred to as a longitudinal direction, and a direction where cells are bundled is referred to as a lateral direction.

An ultrasonic wave basically propagates in the partition walls in the DPF. An ultrasonic wave can propagate in the longitudinal direction in a wide frequency range, but in the lateral direction, there is an ultrasonic wave mode that is likely to propagate depending on the size and material of a cell. For example, when an ultrasonic wave propagates in the ceramic at a sound speed of approximately 3,000 m/s and a cell has a size of several millimeters, the ultrasonic wave corresponds to an ultrasonic wave of approximately several MHz. When PM in exhaust gas is trapped and accumulated on the surfaces of the partition walls or in the pores, an ultrasonic wave is attenuated. It is possible to evaluate the amount of accumulated PM by evaluating the attenuation.

To propagate an ultrasonic wave in the DPF, an ultrasonic transmitting element is provided in contact with a side surface of a main DPF body, a container containing the DPF or the like. There is a case where a heat insulator is arranged between the container and the DPF. In any case, when acoustic impedance greatly changes between the transmitting element and the main DPF body, a reflective component of the ultrasonic wave increases, and thus, adhesion of the transmitting element is attempted using an appropriate method. A piezoelectric element or the like is assumed as the transmitting element. Similarly, a receiving element is provided in order for acoustic impedance not to greatly change between the receiving element and the main DPF body.

It is possible to measure an ultrasonic wave propagating in the longitudinal direction, a wave reflected from the inside of the DPF in locations where the ultrasonic wave transmitting element and the receiving element are provided on the DPF, but in one of the embodiments according to the present invention, the transmitting element and the receiving element are provided at opposing positions in the lateral direction, and attenuation of an ultrasonic wave propagating through the honeycomb structure is evaluated.

A waveform of an ultrasonic wave that is transmitted can have a sine wave or a pulse shape as long as the waveform includes a frequency range that is attenuated by the accumulation of PM. When a pulse-shaped ultrasonic wave is used, it is possible to separate a signal other than an anticipated ultrasonic wave component that propagates in the DPF from a travelling time.

A control apparatus serves to send a necessary electric signal to the ultrasonic wave transmitter, to appropriately process a signal from the receiver and to output the amount of the accumulated PM.

### EXAMPLE

Based on the example of the exhaust gas purification apparatus illustrated in FIG. 1, the method of measuring the amount of accumulated PM according to the present invention will be described. In reference numerals of FIG. 1, 1 indicates an exhaust pipe, 2 indicates a DPF that is configured to have a porous ceramic, 3 indicates an ultrasonic wave transmitter, 4 indicates an ultrasonic receiver, and 5 indicates a control apparatus that processes a detected signal which of an ultrasonic wave the ultrasonic wave transmitter 3 transmits and the ultrasonic wave receiver 4 receives, and measures the amount of accumulated PM. A reference numeral 6 indicates a heat insulator, and a reference numeral 7 indicates a container (for example, a container made of stainless steel), but the heat insulator may not necessarily be required. The heat insulator is intended to insulate the stainless steel container in contact with the porous ceramic from the porous ceramic of which temperature is high due to exhaust gas or regeneration operation. When an ultrasonic wave transceiver is provided on an exterior of the container, the heat insulator is preferably made of a material that prevents signal attenuation of an ultrasonic wave. This is not applied to a case where a port for the measurement is opened in the container and the ultrasonic wave transceiver is directly provided on the main DPF body.

Exhaust gas from a diesel engine flows into the DPF 2 via the exhaust pipe 1. Typically, the DPF 2 is provided in the container via the heat insulating material 6 and the like. The ultrasonic wave transmitter 3 is provided directly on the main DPF 2 body or in contact with the exterior of the container. In FIG. 1, an ultrasonic wave propagates in the lateral direction through the honeycomb structure in the DPF 2. The ultrasonic wave attenuated by the accumulation of the PM is detected by the ultrasonic wave receiver 4 that is similarly provided in contact with the exterior of the container. The control apparatus 5 supplies an electric signal to the ultrasonic wave transmitter, a detected signal from the ultrasonic wave receiver is again input into the control apparatus, and the control apparatus 5 evaluates the amount of the accumulated PM after an appropriate signal process such as amplification or filtering process.

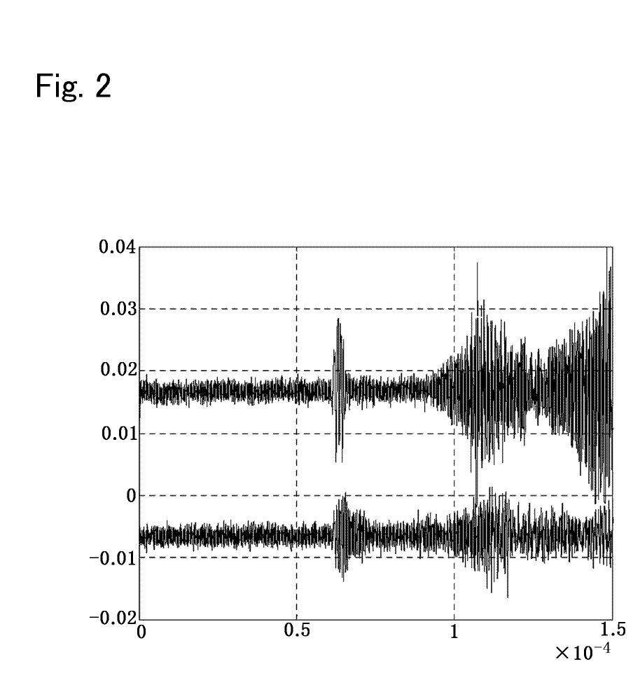

FIG. 2 illustrates waveforms of signals that penetrate in the lateral direction through the DPF with the arrangement when the DPF is charged with PM and the DPF is not charged with PM. In the embodiment, the ultrasonic wave transmitter 3 and the ultrasonic receiver 4 are provided on the side surfaces of the container. A horizontal axis indicates a time, and a vertical axis indicates a relative value of signal intensity. The vertical axis is depicted to be offset for comparison of the waveforms. An incident ultrasonic wave has a waveform of several cycles with a center frequency being approximately several MHz, and the ultrasonic wave is incident at the time of 0 sec in FIG. 2. The penetrating ultrasonic wave is configured to have a part of spectral components from the incident ultrasonic wave. In detected waveforms, since signals first detected around the time of 0.7×10⁻⁴ sec propagate the stainless steel container, the signals are not greatly changed by the accumulation of the PM. Thereafter, second ultrasonic wave signals that propagate in the DPF are detected at a time after the time of 1.1×10⁻⁴ sec. Intensity of the signal that penetrates through the DPF with the PM being accumulated clearly decreases. In a practical evaluation, when the signal that penetrates through the DPF and contains a high frequency component undergoes an appropriate signal process such as a frequency filtering process, an attenuation factor of the amplitude is obtained, and the attenuation factor exceeds a constant value, it is determined that an accumulated amount reaches a level where regeneration operation is necessary. A correlation between the attenuation factor and the accumulated amount is calibrated in advance.

1. A method of measuring the amount of particulate matter (PM) accumulated in an exhaust gas purification apparatus with which a diesel engine is equipped,
wherein a diesel particulate filter (DPF) configured to have a porous ceramic is connected to an intermediate point in an exhaust pipe, a container containing the DPF or the like has an ultrasonic wave transmitter for propagating an ultrasonic wave and an ultrasonic wave receiver for receiving an ultrasonic wave on an exterior thereof, and the amount of the PM accumulated in the DPF is evaluated based on attenuation of a detected signal of the ultrasonic wave propagating through a main DPF body using a control apparatus that processes the detected signal of the ultrasonic wave receiver.

2. The method of measuring the amount of accumulated particulate matter according to claim 1,
wherein the control apparatus evaluates the amount of the PM accumulated in the DPF based on attenuation obtained by comparing amplitude of a detected signal of an ultrasonic wave propagating through the main DPF body when the PM is not accumulated with amplitude of a detected signal of an ultrasonic wave propagating through the main DPF body when the PM is accumulated, and the control apparatus determines that it is necessary to operate regeneration of the DPF when the attenuation exceeds a constant value.

3. The method of measuring the amount of accumulated particulate matter according to claim 1,
wherein an ultrasonic wave of several MHz frequency range is used.

4. The method of measuring the amount of accumulated particulate matter according to claim 1,
wherein a heat insulator made of a material which prevents signal attenuation of an ultrasonic wave is arranged between the main DPF body and the container containing the main DPF body.

5. The method of measuring the amount of accumulated particulate matter according to claim 2,
wherein an ultrasonic wave of several MHz frequency range is used.

6. The method of measuring the amount of accumulated particulate matter according to claim 2,
wherein a heat insulator made of a material which prevents signal attenuation of an ultrasonic wave is arranged between the main DPF body and the container containing the main DPF body.

7. The method of measuring the amount of accumulated particulate matter according to claim 3,
wherein a heat insulator made of a material which prevents signal attenuation of an ultrasonic wave is arranged between the main DPF body and the container containing the main DPF body.

8. The method of measuring the amount of accumulated particulate matter according to claim 5,
wherein a heat insulator made of a material which prevents signal attenuation of an ultrasonic wave is arranged between the main DPF body and the container containing the main DPF body.
